(19) United States
(12) Patent Application Publication
(10) Pub. No.: US 2002/0167165 A1
(43) Pub. Date: Nov. 14, 2002

(54) Thermal insert connection

(76) Inventors: Michael Geiger, Freiberg (DE); Arthur Klotz, Remseck (DE); Thomas Jessberger, Rutesheim (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/102,213

(22) Filed: Mar. 21, 2002

Related U.S. Application Data
(63) Continuation of application No. PCT/EP00/08153, filed on Aug. 22, 2000.

(30) Foreign Application Priority Data
Sep. 21, 1999 (DE) 199 45 219.9

(51) Int. Cl. F16L 55/00

(52) U.S. Cl. 285/187; 285/423

(57) ABSTRACT

A thermal insert connection in which a joint (16) located between a receiving component (12) and an insertable component (10) is sealed by applying a seal (17) which lies on a surface area (20a, 20b) which forms a groove (18) for receiving the seal (17). The seal (17) is first inserted after the thermal insert is assembled and cooled so that the seal is not subjected to thermal stress during the thermal insertion process.

### CROSS REFERENCE TO RELATED APPLICATIONS

This application is a continuation of international patent application no. PCT/EP00/08153, filed Aug. 22, 2000, designating the United States of America, the entire disclosure of which in incorporated herein by reference. Priority is claimed based on Federal Republic of Germany patent application no. DE 199 45 219.9, filed Sep. 21, 1999.

### BACKGROUND OF THE INVENTION

The invention relates to a thermal insert connection, which is formed by fixing an insert element in a receiving element by melting the receiving element. The invention further relates, respectively, to an insert element and a receiving element, which are suitable for use in the aforedescribed thermal insert connection. The invention additionally relates to a method for producing the thermal insert connection.

Thermal insert connections are primarily used for plastic components, which are to be integrated in higher-strength components, e.g., for receiving threads. An example of this is disclosed in published German patent application no. DE 43 22 727 A1. As may be seen, for instance, from FIG. 3 of this document, the insert element has a surface geometry 13a, which displaces the molten material in the receiving element when the insert element is inserted into the receptacle of the receiving element. When the material of the receiving element hardens again after insertion of the insert element, an interlocking connection results to fix the insert element in place. This connection is capable of transmitting large forces, which is required, for example, for the threaded bushings in a throttle valve flange of a synthetic resin intake pipe.

Thermal insertion is thus an economical process, particularly to provide plastic components locally with force application points of increased strength. Furthermore, in the described case of the throttle valve flange, many different applications are conceivable. For instance, the walls of a hollow body, e.g., an intake pipe, could be used to receive thermal insert elements. However, this presents the problem that a seal between the interior and the exterior of the wall cannot be provided by the thermal insert connection itself.

The melting of the material of the receiving element is not sufficient to ensure a complete seal relative to the surface of the insert element. It is possible, however, to configure the seat or receptacle for the insert element as a kind of blind hole, which completely separates the hollow interior space of the intake pipe from the seat. Such an arrangement, however, is not always feasible due to the limited space available.

Furthermore, such a configuration restricts the number of possible functions of the insert elements. For instance, a hose nipple that is intended to establish a connection between a hose and the interior of the intake pipe cannot be inserted into a blind hole, since this would prevent the desired connection from being achieved.

### SUMMARY OF THE INVENTION

The object of the invention is to provide a gas-tight thermal insert connection.

A further object is to provide an insert element and a receiving element, which provide a gas-tight joint when used in the thermal insert connection.

In addition, it is an object of the invention to provide a method for producing an thermal insert connection.

These and other objects are achieved in accordance with the present invention by providing a thermal insert connection comprising an insert element and a receiving element, wherein the receiving element has a lower melting point than the insert element, and wherein a seat for a seal is provided in the area of a joint between the insert and receiving elements, such that inserting the seal produces a tight closure.

In accordance with a further aspect of the invention, the objects are achieved by providing an insert element for a thermal insert connection, wherein the insert element has an effective seal seating area for receiving a seal.

In an additional aspect, the objects are achieved by providing a receiving element for a thermal insert connection, wherein the receiving element has an effective seal seating surface for receiving a seal.

In yet another aspect, the objects of the invention are achieved by providing a method for producing a thermal insert connection comprising an insert element and a receiving element having a lower melting point than the insert element; and wherein a seat or receptacle for a seal is provided in the area of a joint between said insert and receiving elements such that inserting the seal produces a tight closure, said method comprising thermally inserting the insert element in the receiving element; cooling the thermal insert connection to a temperature that is not harmful to the seal; and installing the seal in the seal seat to produce a tight closure.

In the thermal insert connection according to the invention, a seal is provided in the joint between the receiving element and the insert element. For this seal, a seat must be provided in the area of the joint, so that the seal can be mounted after cooling of the thermal insert connection. To produce the insert connection, the insert element must be heated to a temperature that allows the insert element to melt the material of the receiving element. Typically, a seal cannot withstand these temperatures without damage.

The seat for the seal must be configured in such a way that the seal can be subsequently mounted. In other words, fixation means must be provided, which may, for instance, comprise a shoulder on the insert element.

The seal may, for example, comprise an O-ring that is pressed into an annular groove using a special tool. This annular groove is formed partly by the insert element and partly by the receiving element. The inserted seals can also have different cross-sectional shapes, for instance to increase the effective sealing surface. The sealing material, too, may be varied. In addition to elastic materials, such as rubber and elastomers, other materials, which cure in the seat after mounting, are also feasible. These may be liquids, such as synthetic resins, or plastically deformable sealing compounds.

The sealing of the joint between the receiving element and the insert element may be done for different reasons. If the thermal insert connection is provided in a wall-forming structure, the seal results in a complete separation of the media on the two sides of the wall. A suitable application for such an arrangement is in plastic intake pipes where the filtered air in the interior of the intake pipe must be completely sealed off from the environment of the engine compartment. Another possible function of the seal is to prevent corrosion in the joint between the receiving element and the insert element.

The insert element can advantageously be designed as a threaded bushing or a hose nipple or fitting. The threaded bushing is suitable to receive an assembly part. The assembly part itself can be provided with a thread for connection with the threaded bushing.

Another possibility is to fasten the assembly part with a screw, which engages with the threaded bushing. The seal can be arranged so that an additional sealing function is obtained with respect to the assembly part. To achieve this, a partial area of the seal is in contact with the assembly part. This may eliminate an additional seal that might otherwise be required and thus increases the economic efficiency of the inventive arrangment.

If the insert element is a hose nipple, the hose being pushed onto this fitting can simultaneously serve as a seal. The hose itself is made of a resilient material, the elasticity of which can be used as a seal. For this purpose, a seat for the end face area of the hose end must be created in the vicinity of the joint between the receiving element and the insert element. In this seat, the hose is deformed to create the sealing effect.

In accordance with an alternative embodiment of the inventive concept, the sealing effect for the thermal insert connection can also be provided directly between the receiving element and the assembly part to be mounted, without the joint in the thermal insert connection having to be sealed in addition. The joint between the insert element and the receiving element itself is then not sealed, but a leakage flow is prevented since the seal between the assembly part and the receiving element does not permit such leakage. A prerequisite is that the assembly part itself forms a closed volume in interaction with the seal. This is the case, for instance, in a blind hole that is provided with an interior thread to receive the insert element.

The insert elements and the receiving elements that are used to form a sealed thermal insert connection must have appropriate working surfaces to receive the seal. These working surfaces must therefore not only make it possible to install the seal but also subsequently fix it at the installation site.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawings in which:

FIG. 1 is a cross-section of a thermal insert connection, in which a hose fitting sealed by an O-ring is used;

FIG. 2 is a cross-section of a thermal insert connection according to FIG. 1, in which the seal is produced by the hose end, and

FIG. 3 is a cross-section of a thermal insert connection with a threaded fitting or stem onto which an assembly part is screwed, which produces a seal relative to the receiving element by means of an O-ring.

### DETAILED DESCRIPTION OF PREFERRED EMBODIMENTS

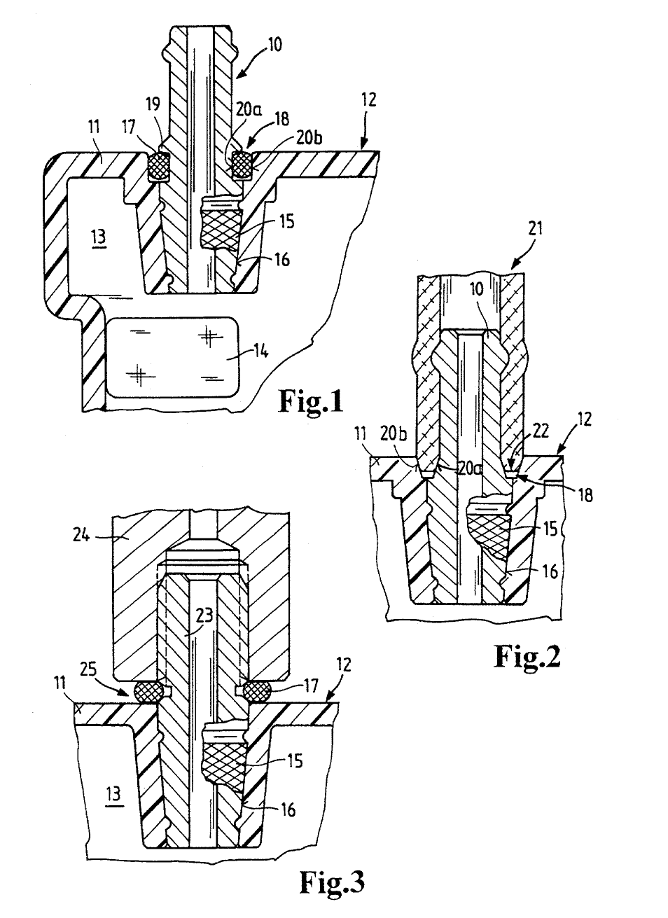

The thermal insert connection according to FIG. 1 comprises a hose fitting or nipple 10 as the insert element, which is inserted into a wall segment 11 of a receiving element 12. The hose fitting is intended to allow the passage of a medium from or into the interior 13 of the receiving element. The interior furthermore contains a functional part 14, e.g., a sensor, which reduces the space available in the area of the thermal insert connection.

The hose fitting 10 is provided with a knurled surface 15. When the hose fitting is inserted, it melts the material of the receiving element 12, which is then partly displaced by the knurl. This creates an interlocking or form-fit connection and fixes the hose fitting in the receiving element. However, the joint 16 produced in this area is not completely tight.

After cooling of the hose fitting, a seal 17 is pressed into a groove 18 that is provided for this purpose. A shoulder 19 ensures the fixation of the seal inside the groove. The groove is formed by a working surface 20a on the hose fitting and a working surface 20b on the receiving element. The seal, in this case an O-ring, sealingly contacts the working surfaces.

The thermally inserted hose fitting according to FIG. 2 is constructed analogously to the arrangement described in FIG. 1. The only distinguishing feature is the configuration of groove 18, which does not have a shoulder. A hose 21 is pushed onto the hose fitting 10 such that its end 22 contacts the working surfaces 20a and 20b. The groove has a trapezoidal cross section, so that the hose end is elastically deformed when it is inserted. This produces the sealing effect. To maintain this sealing effect despite vibrations and temperature fluctuations, the fitting 10 advantageously has a form-fit design.

The thermal insert connection according to FIG. 3 uses a threaded stem 23 as the insert element. A threaded bushing could be used analogously. This bushing would be distinguished from the threaded stem only by an interior thread instead of an exterior thread. The threaded stem is inserted into the receiving element analogously to the arrangement according to FIG. 1. An assembly part 24 is screwed onto this stem. This assembly part together with the receiving element 12 forms a joint 25 into which a seal 17 is inserted. By screwing the assembly part onto the stem, the seal is elastically deformed to produce the sealing effect between the assembly part 24 and the receiving element 12.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. A thermal insert connection comprising an insert element and a receiving element, wherein the receiving element has a lower melting point than the insert element, and wherein a seat for a seal is provided in the area of a joint between the insert and receiving elements such that inserting the seal produces a tight closure.

2. A thermal insert connection according to claim 1, wherein the seat comprises a groove having walls which are formed by the receiving element and the insert element.

3. A thermal insert connection according to claim 1, wherein the insert element is a threaded insert.

4. A thermal insert connection according to claim 1, wherein the seal simultaneously sealingly engages an assembly part mounted on the insert connection.

5. A thermal insert connection according to claim 1, wherein the insert element is a hose nipple.

6. A thermal insert connection according to claim 5, wherein a hose that is pushed onto the hose nipple simultaneously acts as a seal for the thermal insert connection.

7. A thermal insert connection comprising an insert element and a receiving element, wherein the receiving element has a lower melting point than the insert element; an assembly part is mounted to the thermal insert connection, and a seat for a seal is provided in the area of a joint between the assembly part and the thermal insert connection such that inserting the seal produces a tight closure of the joint.

8. An insert element for a thermal insert connection, wherein said insert element has a working surface forming a seat for receiving a seal.

9. A receiving element for a thermal insert connection, wherein said receiving element has a working surface forming a seat for receiving a seal.

10. A method for producing a thermal insert connection comprising an insert element and a receiving element having a lower melting point than the insert element; and wherein a seat for a seal is provided in the area of a joint between said insert and receiving elements such that inserting the seal produces a tight closure, said method comprising hot-inserting the insert element in the receiving element; cooling the thermal insert connection to a temperature that is not harmful to the seal; and installing the seal in the seal seat to produce a tight closure.
